(19) United States
(12) Patent Application Publication
(10) Pub. No.: US 2004/0208009 A1
(43) Pub. Date: Oct. 21, 2004

(54) Lighting unit with improved cooling

(76) Inventors: Paul Francis Mardon, Cambridge (GB); Mark Leonard Gregory, Cambridge (GB)

Correspondence Address: Lee Mann Smith McWilliams, Sweeney & Ohlson, P O Box 2786, Chicago, IL, 60690-2786, US

(21) Appl. No.: 10/480,092

(22) PCT Filed: Jun. 12, 2002
(86) PCT No.: PCT/GB02/02618

(30) Foreign Application Priority Data
Jun. 12, 2001 (GB) 0114222.3

(51) Int. Cl. B60Q 1/06

(52) U.S. Cl. 362/373

(57) ABSTRACT

Disclosed is a lighting unit comprising at least one light emitting diode (50), means for supplying power to the light emitting diode (50), and a motor driven pump means (18) for generating a stream of fluid for cooling the light emitting diode (50). The pump means is mounted in a resiliently compressible member (48) for absorbing vibrations produced by the pump means (18) which reduces the level of noise produced by the lighting unit. The lighting unit has control means operable to gradually increase or decease the speed of operation of the pump means in response to the power dissipation of the light emitting diode exceeding or falling below, respectively, a threshold level, which makes the noise produced by the pump means less noticeable.

### FIELD OF THE INVENTION

This invention relates to a lighting unit, and in particular to a lighting unit comprising at least one light emitting diode.

### BACKGROUND TO THE INVENTION

Lighting units that use a plurality of light emitting diodes (LEDs) are known. These typically comprise a plurality of each of red, green and blue LEDs, control of the relative brightness of which determines the colour of light generated by the lighting unit. It has been found that the luminous efficiency of the LEDs used in such lighting units falls rapidly if their operating temperature is permitted to exceed about 40° Celsius while operating at higher currents. To date, therefore, such lighting units have employed a sheet of a highly thermally conductive material that is placed in good thermal contact with, and conducts heat away from, the LEDs. However, the highly thermally conductive material is very expensive and provides a relatively inefficient means of cooling the LEDs, which must be used at currents less than their maximum rated currents.

### SUMMARY OF THE INVENTION

According to the invention, there is provided a lighting unit comprising at least one light emitting diode (LED), means for supplying power to said diode and a motor driven pump means for generating a stream of fluid for cooling the diode.

Preferably, the pump means comprises a fan which is operable to create a stream of air for causing said cooling.

It has been found that a fan provides an effective and relatively cheap means of cooling the diode, and enables the diode to be used at higher outputs than the known types of diode cooling systems, which rely purely on thermal conduction to a highly conductive cooling material.

Preferably, the unit includes means for allowing or causing the air stream created by the fan to cool the LED from behind (i.e. from the end of the LED opposite that from which the majority of light is emitted in use).

This can be achieved by, for example, allowing or causing the air stream to impinge directly on the rear of the LED or on an element thermally coupled to the rear of the LED.

The unit may include ducting means for channelling the air stream from the fan to the diode or element. Conveniently, however, the diode or element is situated directly in front of the fan, and hence in the stream of air from the fan.

Preferably, the diode is one of an array of such diodes mounted on one face of a support board, the unit including coupling means thermally coupling each LED to an element on the other face of the board, wherein, in use, said stream of air is directed over said other face.

Preferably, the coupling means is provided by an electrical conductor for electrically connecting the diode to the power supply means. Said conductor preferably comprises the cathode leg of its respective LED.

Preferably, the surfaces of the board onto which said air stream is directed carries a thermally conductive layer of, for example, copper.

Preferably, the LED array and fan are mounted in a housing having an air inlet opening for said air to cool the array and an air outlet opening which acts as an exhaust for the air which has cooled the array, wherein the inlet and the outlet are situated generally behind the array, preferably at the rear of the housing.

Preferably, one of the openings is annular, and encircles the other opening. Preferably, the annular opening is the air outlet.

Preferably, the housing comprises an outer member into which a tubular core member extends, the fan being mounted within the core member.

Preferably, the core member defines the inlet, is spaced from the back of the board to allow said air stream to pass between the board and the core member and is so spaced from the outer member as to define said annular outlet.

Preferably, the unit includes sealing means for preventing passage of air from the fan to the region in front of the board, so as to prevent any particles blown by the fan passing into the path of the light being emitted by the unit.

Preferably, the fan is mounted in the core member through a resiliently compressible, preferably annular, member for absorbing vibrations produced by the fan.

Preferably, the compressible member is compressed between the core member and the fan thereby to retain the fan in the core member.

Preferably, the unit includes control means for activating the fan, wherein the control means activates the fan by supplying a progressively increasing voltage thereto, so as to produce a gentle acceleration of the fan blades up to the normal operating speed of the fan.

Preferably, the control means is so arranged as to increase the speed of movement of the fan blades from standstill to the normal operating speed in not less than 10 seconds.

Noise generated by the gradual activating of the fan is less noticeable than would have been the case if the fan were rapidly activated.

Preferably, the control means is also operable to deactivate the fan by gradually reducing the speed so as to remove residual heat from the array after the latter has stopped generating sufficient heat to require cooling.

Preferably, the control means is operable to activate the fan when the power supply to the LED array exceeds a threshold, and to deactivate the fan when the power drops below a threshold, preferably the same threshold.

Preferably, the unit includes a reflector member comprising a piece of sheet material having a number of apertures, each in a respective depression in the material, wherein each LED extends through a respective aperture and wherein each associated depression reflects light emitted from the sides of the LED forwardly from the unit.

The invention will now be described in greater detail by way of an illustrative example and with reference to the accompanying drawings, in which:

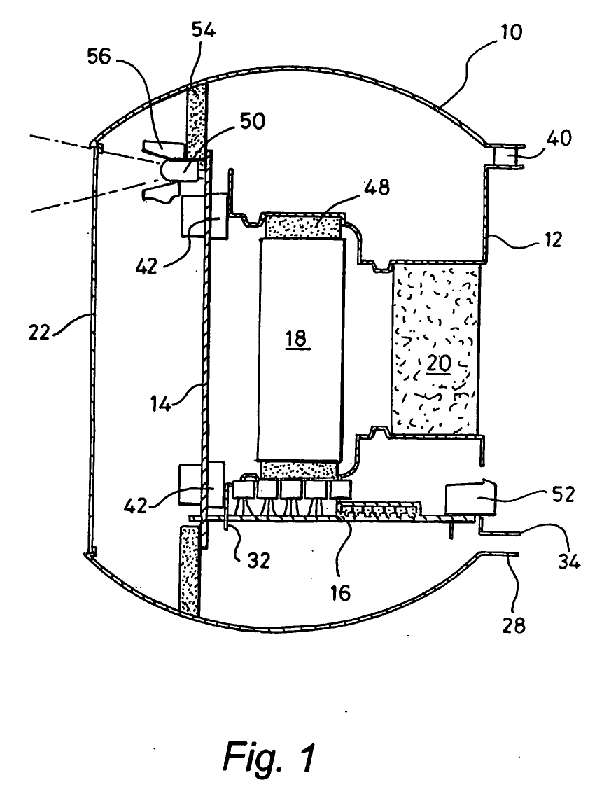

FIG. 1 is a cutaway side view of a lighting unit;

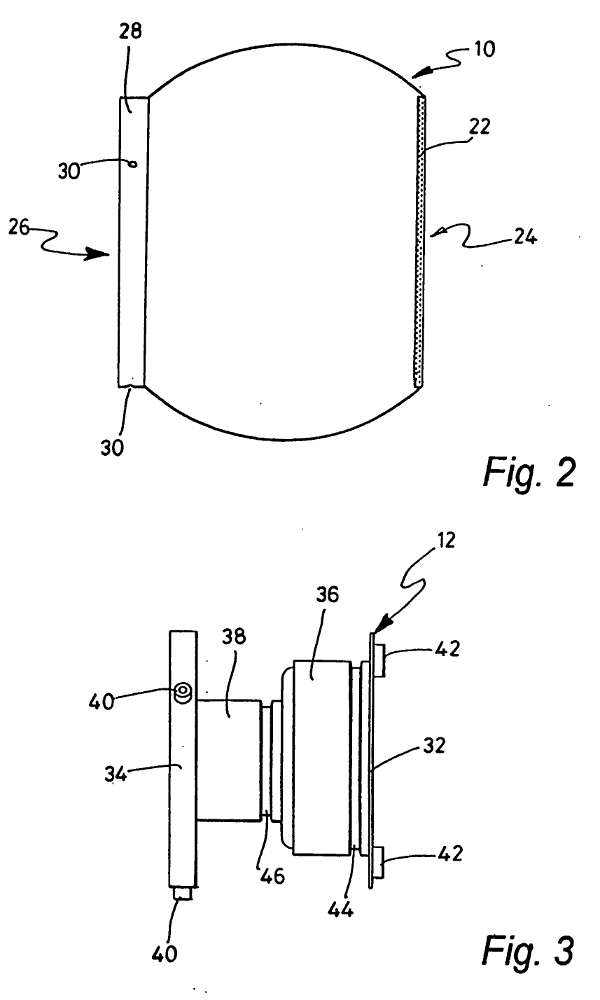

FIG. 2 is a cutaway side view of the housing and diffusing lens;

FIG. 3 is a side view of the core;

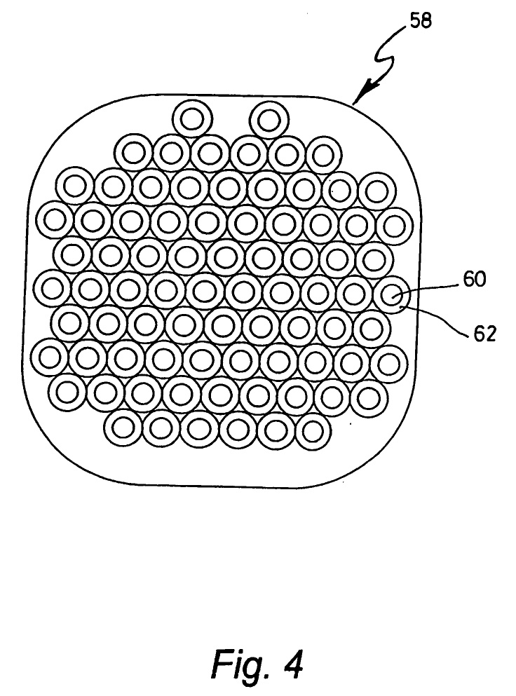

FIG. 4 is a plan view of the reflector; and

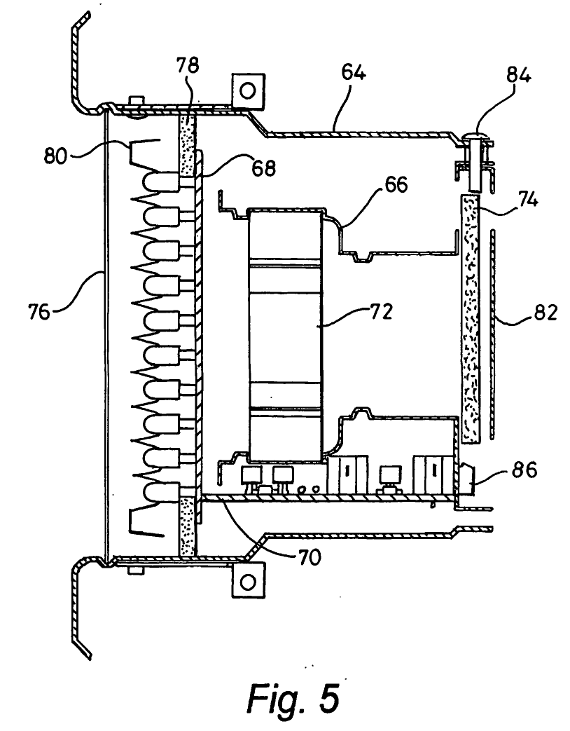

FIG. 5 is a cutaway side view of another lighting unit.

### DETAILED DESCRIPTION OF EMBODIMENTS

Referring to FIG. 1, a lighting unit comprises a housing 10 containing a core 12, first and second circuit boards 14 and 16 respectively, an electric fan 18, a filter 20 and a diffusing lens 22. The core 12 is fastened to the housing 10 by screws (not shown). The first and second circuit boards are joined at right angles along one edge and the first circuit board 14 is fastened to the core 12 by screws (not shown).

Referring to FIG. 2, the housing 10 is formed from aluminium and is generally tubular with convex walls and front and rear circular openings 24 and 26 respectively. The front opening 24 has an integrally formed bezel to retain the diffusing lens 22, which is moulded from polycarbonate. The rear opening 26 is formed with a tubular rim 28. The rim 28 has three screw holes 30 spaced equi-angularly around its circumference, of which two are visible in FIG. 2.

Referring to FIG. 3, the core 12 is formed from aluminium and is generally tubular with front and rear flanges 32 and 34, the front flange 32 being formed at the first end of a wide portion 36 of the core and the rear flange 34 being formed at the second end of a narrow portion 38 of the core. The external surfaces and internal surfaces (not shown) of the wide and narrow portions of the core are cylindrical. The second end of the wide portion 36 and the first end of the narrow portion 38 are joined. The rear flange 34 is annular with three tapped, radially outwardly projecting studs 40 projecting from equally spaced points on its circumference, of which two are visible in FIG. 3.

The front flange 32 is rectangular with a tapped, axially outwardly projecting stud 42 at each corner, of which two are visible in FIG. 3. The wide and narrow portions 36 and 38 have respective swaged portions 44 and 46 near to their respective first ends, which form annular steps on their internal surfaces.

Referring again to FIG. 1, the fan 18 is located in the wide portion (denoted in FIG. 3 by reference numeral 36) of the core 12. The fan is mounted in a resilient annular foam rubber pad 48, the outer diameter of which is greater than the internal diameter of the wide portion of the core so that the pad 48 is compressed between the core and the fan. The resilience of the pad 48 secures the fan relative to the core and further serves to absorb vibration from the fan motor which would otherwise be transmitted to the core and housing. The annular step (which corresponds to the swaged portion denoted in FIG. 3 by reference numeral 44) on the internal surface of the wide portion prevents any axial movement of the fan and pad relative to the core.

The filter 20 is located in the narrow portion (denoted in FIG. 3 by reference numeral 38) of the core. The filter is circular and formed from a resilient foam. The external diameter of the filter is greater than that of the narrow portion and the resilience of the foam secures the filter relative to the core. The annular step (which corresponds to the swaged portion denoted in FIG. 3 by reference numeral 46) on the internal surface of the narrow portion prevents movement of the filter towards the fan.

The first and second circuit boards 14 and 16 are rigidly joined at right angles to one another. The first circuit board 14 has a 5 oz/ft² tinned copper layer on both its front and rear surfaces. The second circuit board 16 has a 2 oz/ft² tinned copper layer on both its front and rear surfaces.

The first circuit board 14 is provided with a rectangular slot parallel with one of its edges. The slot is of the same width as the thickness of the second circuit board 16. The tinned copper layer on the rear surface of the first circuit board is formed with one large pad adjacent to each of the shorter edges of the slot, and seven small pads adjacent to each of the longer edges of the slot.

The second circuit board 16 has a rectangular cut-out at two of its corners so as to form a rectangular tab. The tab is of the same width as the length of the slot in the first circuit board 14. The tinned copper layer on both front and rear surfaces of the second circuit board is formed with one large pad to either side of the tab, and with seven small pads on the tab itself.

The first and second circuit boards are fastened together by placing the tab of the second circuit board into the slot of the first circuit board, such that each large pad of the first board is adjacent to a large pad of the second board, and each of the seven small pads on each side of the tab of the second circuit board is adjacent to a corresponding pad on the first circuit board. Each pair of adjacent pads is soldered together.

An approximately circular array of 80 through hole high intensity LEDs is arranged on the front surface of the first circuit board. One such LED is shown in FIG. 1, denoted by reference numeral 50. The remaining LEDs have been omitted for the purpose of clarity.

The 80 LEDs are made up of three chains of nine red LEDs, seven chains of five green LEDs, and three chains of six blue LEDs. The LEDs of each colour are arranged as several chains in parallel so that failure of an LED affects only the chain of which that LED forms a part. The number of LEDs in each chain is chosen to ensure that, as far as possible, the voltages developed across the chains are approximately equal.

The tinned copper layer on the front surface of the first circuit board is etched in the immediate vicinity of the holes through which the leads of each LED pass, to prevent short circuits between the LEDs, but otherwise left substantially intact, so as to act as a heat spreader, and painted white so as to act as a reflector. The leads of the LEDs are soldered to the copper layer on the rear surface of the board, which is etched so as to form the current paths for the red, green and blue LED circuits, but is otherwise as far as possible left intact, to maximise the area of the copper layer in thermal contact with the cathode lead of each LED. The large surface area of tinned copper on the rear face of the board facilitates the transfer of heat away from the LEDs.

The second circuit board 16 comprises an electrical connector 52, three voltage-controlled current sinks, namely one current sink for each colour of LED, a comparator and a variable voltage source. The connector is accessible through a cut-out in the rear flange of the core and provides connections for an external 24 V dc power supply, three standard 0 to 10 V lighting control signal lines, namely one control signal line for each colour of LED, and a common signal and supply ground. Each voltage-controlled current source is connected to the corresponding control signal line.

The 24 V dc power supply is connected to the large pads to either side of the tab. The voltage-controlled current sink associated with the red, green and blue LEDs is connected, respectively, to three, seven and three of the small pads on the tab. One of the small pads on the tab is therefore not used. Current flows to the LEDs from the 24 V dc power supply via the large pads on the first circuit board and from the LEDs to the voltage-controlled current sinks via thirteen of the fourteen small pads on the tab.

The current flowing through the three red, seven green and three blue chains of LEDs is proportional to the magnitude of the corresponding 0 to 10 V control signal, enabling coloured light to be produced in a known fashion.

The comparator monitors the current supplied to the LEDs in response to the 0 to 10 V dc control signals and switches on the fan if the current exceeds a threshold level of 10% of the maximum current. The voltage applied to the fan by the voltage supply is variable, such that when the comparator detects that the LED current has exceeded the threshold level the voltage applied to the fan ramps from 0V to 24V over approximately 10 seconds. Similarly, if the comparator subsequently detects that the LED current has fallen below the threshold level in response to the 0 to 10V dc control signals, the voltage applied to the fan ramps from 24V to 0V over approximately 30 seconds. This soft starting and stopping of the fan makes the noise from the fan motor less intrusive because the changes in noise are gradual.

The first circuit board 14 is generally rectangular and has a screw hole at each corner. The first circuit board is attached to the core 12 through the screw holes by four aluminium screws, one into each of the tapped aluminium studs denoted in FIG. 3 by 42, so that the fan 18 is a short distance from the tinned copper layer on the rear surface of the first board. The tinned copper layer on the front surface of the first circuit board is not painted in the vicinity of the screw holes, so as to ensure a good thermal contact between the head of each of the aluminium screws and the tinned copper layer on the front surface of the first circuit board. The aluminium screws thus provide a path for the conduction of heat from the front surface of the first circuit board to the core, which acts as a heatsink. In addition to securing the first circuit board to the core, the aluminium screws bring the tinned copper layer on the rear surface of the first circuit board into good thermal contact with the tapped studs on the front flange of the core, which provide a path for the conduction of heat from the rear surface of the first circuit board to the core.

The assembly of the core, fan, pad, filter and first and second circuit boards is secured inside the housing by three screws through the holes in the housing denoted in FIG. 2 by 30 into the tapped studs on the rear flange of the core, denoted in FIG. 3 by reference numerals 40 and 34 respectively. An annular foam rubber seal 54 between the internal surface of the housing and the periphery of the first circuit board prevents the ingress of dust, insects and the like into the cavity formed by the first circuit board 14, seal 54 and housing 10.

A reflector is located over the array of LEDs to direct light emitted from the sides of the LEDs towards the diffusing lens 22. The reflector comprises a metallised injection moulding. A portion of the reflector, denoted by reference numeral 56, is shown fitted to LED 50. FIG. 4 shows the entire reflector 58. The reflector has a plurality of apertures, e.g. 60, each surrounded by a respective dished recess, e.g. 62. A respective LED extends through each aperture so that the light emitted from the sides of the LED is reflected forwardly, through the lens 22 by the associated recess.

In use the fan 18 draws a stream of air from the rear of the lighting unit through the filter 20 in the narrow portion of the core 12. The stream of air is directed onto the centre of the rear surface of the first circuit board 14, spreads outwards to the periphery of the board and is heated by the tinned copper layer. The air then passes through the gaps between the board 14 and the flange 32 of the core. The stream of heated air is exhausted from the lighting unit between the rear flange 34 of the core and the rim 28 of the housing, thus conducting heat away from the LEDs. The lighting unit would typically be recessed into a ceiling of a room, such that air is drawn into the unit from, and is exhausted from the unit into, a space above the ceiling. This, together with the isolation of the fan by the pad 48 and the soft starting and stopping of the motor, further reduces the transmission of noise from the fan motor into the room.

Referring to FIG. 5, another lighting unit in accordance with the invention comprises a housing 64, core 66, first and second circuit boards 68 and 70 respectively, an electric fan 72, a filter 74, a diffusing lens 76, a seal 78, a reflector 80, and a back plate 82. The housing 64 is formed from aluminium and is generally tubular with straight walls and front and rear circular openings. The front opening has an integrally formed bezel to retain the diffusing lens 76, which is identical with the diffusing lens 22 of FIG. 1.

The first and second circuit boards 68 and 70, electric fan 72 and seal 78 are identical with the first and second circuit boards 14 and 16, electric fan 18 and seal 54 of FIG. 1.

The core 66 is substantially identical with the core 12 of FIG. 3, with the exception of the rear flange, which is formed without the three radially outwardly projecting studs denoted in FIG. 3. Instead aluminium nuts are pressed through the rear flange so that the nuts are retained by the flange and project radially outwards from the flange.

The core 66 is fastened to the housing 64 by screws, one of which is shown in FIG. 5, denoted by reference numeral 84. The back plate 82 is circular with a raised lip, and is formed with an array of apertures that allow air to be drawn into the lighting unit by the fan 72, and give access to an electrical connector 86 on the second circuit board 70. The filter 74 is retained between the back plate 82 and the rear flange of the core 66. It has been found that by locating the filter further from the fan, less noise is generated by the passage of air through the filter, and the operation of the lighting unit of FIG. 5 is quieter than the operation of the lighting unit of FIG. 1.

The raised lip of the back plate is provided with holes, through which the screws such as 84 pass, so as to fasten the back plate to the housing 64. The back plate 82 is smaller in diameter than the rear opening of the housing, such that when the back plate is fastened to the housing, an annular opening is formed between the raised lip of the back plate and the housing, through which heated air may be exhausted from the lighting unit.

The reflector 80 is a polyvinyl chloride vacuum forming on which a layer of aluminium is deposited, and a layer of clear lacquer applied to the aluminium layer.

It will be apparent that the above description relates only to two embodiments of the invention, and that the invention encompasses other embodiments as defined by the claims set out hereafter.

1. A lighting unit comprising at least one light emitting diode (led), means for supplying power to the at least one led, and a motor driven pump means for generating a stream of fluid for cooling the at least one led:

2. A lighting unit according to claim 1, wherein the pump means comprises a fan which is operable to create a stream of air for cooling the at least one LED.

3. A lighting unit according to claim 1, which includes control means for activating the fan by supplying a progressively increasing voltage thereto, so as to produce a gentle acceleration of the fan blades up to a normal operating speed of the fan.

4. A lighting unit according to claim 3, wherein the control means is adapted to increase the speed of movement of the fan blades from standstill to the normal operating speed in not less than ten seconds.

5. A lighting unit according to claim 3, wherein the control means is adapted to deactivate the fan by gradually reducing the speed of movement of the fan blades so as to reduce residual heat from the at least one LED after the at least one LED has stopped generating sufficient heat to require cooling.

6. A lighting unit according to claim 3, wherein the control means is operable to activate the fan when the power supply to the at least one LED exceeds a first threshold, and to deactivate the fan when the power supply to the at least one LED drops below a second threshold.

7. A lighting unit according to claim 6, wherein the first threshold is equal to the second threshold.

8. A lighting unit according to claim 2, wherein the stream of air created by the fan impinges directly on the rear of the at least one LED or on an element thermally coupled to the rear of the at least one LED.

9. A lighting unit according to claim 8, which includes ducting means operable to channel the stream of air from the fan to the at least one LED or element thermally coupled to the rear of the at least one LED.

10. A lighting unit according to claim 2, wherein the at least one LED forms part of an array of LEDs mounted on a first face of a support board.

11. A lighting unit according to claim 10, which includes coupling means for thermally coupling each of the array of LEDs to an element on a second face of the support board, wherein, in use, the stream of air from the fan is directed over the second face of the support board.

12. A lighting unit according to claim 11, wherein the coupling means is provided by an electrical conductor for electrically connecting each of the array of LEDs to the power supply means.

13. A lighting unit according to claim 12, wherein the coupling means is provided by the cathode lead of each of the array of LEDs.

14. A lighting unit according to claim 11, wherein at least the second surface of the support board carries a thermally conductive layer.

15. A lighting unit according to claim 14, wherein the thermally conductive layer is formed from tinned copper.

16. A lighting unit according to claim 2, wherein the at least one LED and fan are mounted in a housing having an air inlet opening for the stream of air before it has cooled the at least one LED, and an air outlet opening which acts as an exhaust for the stream of air after it has cooled the at least one LED, wherein the inlet and outlet openings are situated generally behind the at least one LED.

17. A lighting unit according to claim 16, wherein the inlet and outlet openings are situated at the rear of the housing.

18. A lighting unit according to claim 17, wherein one of the openings is annular and encircles the other opening.

19. A lighting unit according to claim 18, wherein the annular opening is the air outlet opening.

20. A lighting unit according to claim any of claims 19, wherein the housing comprises an outer member into which a tubular core member extends, and the fan is mounted in the core member.

21. A lighting unit according to claim 20, wherein the core member defines the air inlet opening, is located relative to the support board such that the stream of air from the fan passes between the second surface of the support board and the core member, and is located relative to the outer member so as to define the annular air outlet opening.

22. A lighting unit according to claim 21, which includes sealing means adapted to prevent passage of air from the fan to the region in front of the first surface of the support board.

23. A lighting unit according to claim 20, wherein the fan is mounted in the core member through a resiliently compressible member operable to absorb vibrations produced by the fan.

24. A lighting unit according to claim 23, wherein the compressible member is annular and is compressed between the core member and the fan so as to retain the fan in the core member.

25. A lighting unit according to claim 10, which includes a reflector member comprising a piece of sheet material having a plurality of apertures, each aperture being located in a respective depression in the material, wherein each LED extends through a respective aperture and the associated depression reflects light emitted from the sides of the LED forwardly from the lighting unit.

26. (Cancelled)
